(19) United States
(12) Patent Application Publication
(10) Pub. No.: US 2020/0302527 A1
(43) Pub. Date: Sep. 24, 2020

(54) BLOCKCHAIN SMART CONTRACTS FOR EMPLOYEE STOCK OPTION TOKENS

(71) Applicant: BLOOMIO AG, Zug (CH)

(72) Inventors: Max LYADVINSKY, Moscow (RU); Alexey RAEVSKY, Moscow (RU); Anton PETRUSHKIN, Moscow (RU)

(21) Appl. No.: 16/358,761

(22) Filed: Mar. 20, 2019

(51) Int. Cl. G06Q 40/04; G06Q 20/40; G06Q 20/36

(52) U.S. Cl. CPC G06Q 40/04; G06Q 2220/00; G06Q 20/3676; G06Q 20/401

(57) ABSTRACT

Disclosed are systems and methods for generating a blockchain data structure for executing an employee stock ownership plan. The described system generates and deploys within a blockchain an employee stock ownership plan (ESOP) smart contract that is associated with a subset of equity tokens representing an equity stake of a company. The ESOP smart contract has program code for constructor functionality that creates a plurality of stock option tokens corresponding to the subset of the equity tokens in the first electronic wallet associated with the company, and code for transfer functionality that converts at least a portion of the stock option tokens in a second electronic wallet to a corresponding amount of equity tokens in accordance with one or more verification rules and checks.

### FIELD OF TECHNOLOGY

The present disclosure relates generally to the field of cryptocurrencies and blockchain-based transactions, more specifically, to systems and methods for managing and executing an employee stock ownership plan using blockchain-based smart contracts.

### BACKGROUND

Cryptographic assets (also referred to as crypto assets) refer to a technology of digital assets that are managed using cryptographic techniques, for example, to secure the transactions of, control the creation of additional assets (i.e., “mining”), and verify the transfer of such assets. Examples of crypto assets may include cryptographic currency (cryptocurrency assets), utility tokens (e.g., app coins, user tokens), security tokens, or other similar assets. Blockchain technology is an emerging technology that has been used in cryptocurrency implementations. The blockchain is a data structure that stores a list of transactions and can be thought of as a distributed electronic ledger that records transactions between a source and a destination, or a sender and a recipient. The transactions are batched together into blocks and every block refers back to or is linked to a prior block in the chain. Computer nodes, sometimes referred to as miners, maintain the blockchain and cryptographically validate each new block (and the transactions contained therein) using a proof-of-work system or other schemes.

Some blockchain technologies support the publication of smart contracts on the blockchain. Smart contracts contain computer-executable program code representing the functionality of the smart contract and data representing the state of the smart contract, all of which reside in the blockchain. Smart contracts contain code functions, can interact with other smart contracts, make decisions, store data which is persisted within the blockchain, and send cryptographic assets to others. Smart contracts' execution (and resulting functionality) are provided by the blockchain network itself, for example, by one of the computer nodes that maintain the blockchain.

### SUMMARY

Thus, a system and method is disclosed herein for executing blockchain-based smart contracts, and, more particularly, for managing and executing an employee stock ownership plan using blockchain-based smart contract. According to one aspect, a computer-implemented method is provided for generating a blockchain data structure for executing an employee stock ownership plan. The method includes allocating a plurality of equity tokens to a first electronic wallet associated with a company. Each equity token represents a stake in equity in the company. The method further includes generating a first transaction data structure storing an employee stock ownership plan (ESOP) smart contract module that is associated with a subset of the plurality of equity tokens. The ESOP smart contract module includes computer-executable instructions configured to execute, at a server-side node, constructor functionality that creates a plurality of stock option tokens corresponding to the subset of the equity tokens in the first electronic wallet associated with the company. The ESOP smart contract module further includes computer-executable instructions configured to execute, at the server-side node, transfer functionality that converts at least a portion of the stock option tokens in a second electronic wallet to a corresponding amount of equity tokens. The method further includes publishing the first transaction data structure storing the ESOP smart contract module to a decentralized ledger maintained by a network of server-side nodes. The method includes transmitting a second transaction data structure that specifies a recipient as a blockchain address of the ESOP smart contract module, wherein the second transaction data structure invokes transfer functionality of the ESOP smart contract module for transferring at least one stock option token to an electronic wallet associated with an employee of the company.

In another aspect, the transfer functionality of the ESOP smart contract module includes computer-executable instructions configured to verify one or more rules associated with a requested conversion of the portion of the stock option tokens to the corresponding amount of equity tokens; responsive to verifying the requested conversion, transfer the corresponding amount of equity tokens to the second electronic wallet; and responsive to not verifying the requested conversion, refraining from transferring the corresponding amount of equity tokens to the second electronic wallet.

In another aspect, the ESOP smart contract module further includes computer-executable instructions configured to verify that a receipt datetime of an invocation of the transfer functionality that converts a stock option token to an equity token is not earlier than a predefined datetime value.

In another aspect, the ESOP smart contract module defines the predefined datetime value is specified relative to a datetime value that the ESOP smart contract module is published to the distributed ledger.

In another aspect, the ESOP smart contract module further includes computer-executable instructions configured to verify that an amount of stock option tokens requested for conversion does not exceed a predefined amount of allowed number of equity tokens for a current datetime.

In another aspect, the ESOP smart contract module further includes computer-executable instructions configured to verify that an amount of cryptocurrency coins is transferred to the first electronic wallet associated with the company.

In another aspect, the step of allocating the plurality of equity tokens includes deploying a tokens smart contract sub-module to the distributed ledger.

In another aspect, the transfer functionality of the ESOP smart contract module includes computer-executable instructions configured to modify an internal data store of the server-side node that represents an execution state of the ESOP smart contract module to update a balance of stock option tokens for the second electronic wallet and the first electronic wallet associated with the company.

In another aspect, the ESOP smart contract module specifies a total supply value that equals the number of tokens in the subset of equity tokens.

According to another aspect of the present disclosure, a system for generating a blockchain data structure for executing an employee stock ownership plan is provided. The system includes a memory and a hardware processor coupled to the memory. The hardware processor is configured to allocate a plurality of equity tokens to a first electronic wallet associated with a company. Each equity token represents a stake in equity in the company. The hardware processor is further configured to generate a first transaction data structure storing an employee stock ownership plan (ESOP) smart contract module that is associated with a subset of the plurality of equity tokens. The ESOP smart contract module includes computer-executable instructions configured to execute, at a server-side node, constructor functionality that creates a plurality of stock option tokens corresponding to the subset of the equity tokens in the first electronic wallet associated with the company, and execute, at the server-side node, transfer functionality that converts at least a portion of the stock option tokens in a second electronic wallet to a corresponding amount of equity tokens. The hardware processor is further configured to publish the first transaction data structure storing the ESOP smart contract module to a decentralized ledger maintained by a network of server-side nodes, and transmit a second transaction data structure that specifies a recipient as a blockchain address of the ESOP smart contract module. The second transaction data structure invokes transfer functionality of the ESOP smart contract module for transferring at least one stock option token to an electronic wallet associated with an employee of the company.

According to another exemplary aspect, a computer-readable medium is provided comprising instructions that comprises computer executable instructions for performing any of the methods disclosed herein.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for executing employee stock options plans using blockchain transactions, according to an exemplary aspect.

FIG. 2 is a block diagram depicting operations for issuing and converting employee stock option tokens using a blockchain smart contract, according to an exemplary aspect.

FIG. 3 is a block diagram depicting a schematic view of an employee stock ownership plan (ESOP) smart contract module having a plurality of sub-modules, according to an exemplary aspect.

FIG. 4 is a flowchart of a method for executing employee stock options plans using blockchain transactions and smart contracts according to an exemplary aspect.

FIG. 5 is a block diagram of a computer system on which the disclosed system and method can be implemented according to an exemplary aspect.

### DETAILED DESCRIPTION

Exemplary aspects are described herein in the context of a system, method, and computer program product for executing a blockchain smart contract for employee stock option tokens. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

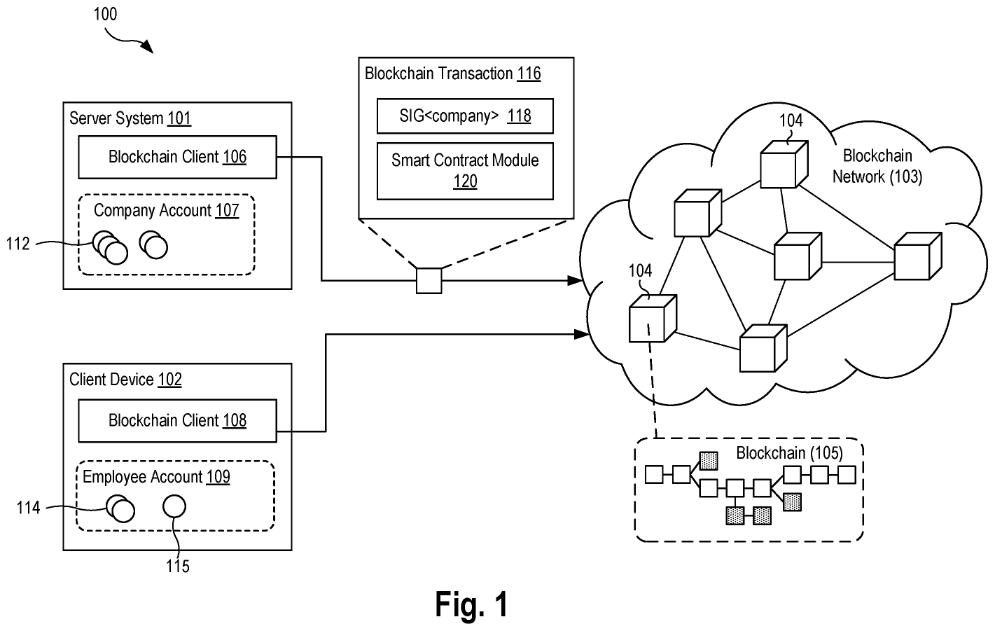

FIG. 1 is a block diagram of a system 100 for executing employee stock options plans using blockchain transactions, according to an exemplary aspect. The system 100 may include one or more server systems 101 associated with a company, one or more client device(s) 102 associated with an employee of that company, and a blockchain network 103. The client device 102 may be one of personal computers, servers, laptops, tables, mobile devices, smart phones, cellular devices, portable gaming devices, media players or any other suitable devices that can retain, manipulate and transfer data.

The server system 101 may include a blockchain client 106, which is a software application configured to generate and transmit one or more cryptocurrency or blockchain-based transactions to the blockchain network 103 for facilitating the management and execution of an employee stock option plan. The client device 102 may include a similar blockchain client, shown as blockchain client 108. The blockchain client 106 is configured to manage an account (sometimes referred to as a “wallet”) controlled by a private encryption key and having an account balance of cryptographic assets. In some aspects, the blockchain client 106 may manage an account by maintaining private and public encryption key pairs tied to an account, and generating a plurality of transaction data structures having a cryptographically-signed data package (e.g., signed by a private encryption key) that specify the transfer of cryptocurrency assets, generating unique cryptocurrency addresses to be used for transactions, and other related functionality.

According to an exemplary aspect, the blockchain network 103 can be a distributed peer-to-peer network formed from a plurality of nodes 104 (computing devices) that collectively maintain a distributed ledger, also referred to as a blockchain 105. The blockchain 105 is a continuously-growing list of data records hardened against tampering and revision using cryptography and is composed of data structure blocks that hold the data received from other nodes 104 or other client nodes, including the client device 102 and server systems 101 executing an instance of the blockchain client 106. The blockchain client 106 is configured to transmit data values to the blockchain network 103 as a transaction data structure 111, and the nodes 104 in the blockchain network records and validates/confirms when and in what sequence the data transactions enter and are logged in the existing blockchain 105. The transaction data structure 111 may contain computer-executable code, or a reference to computer-executable code stored in an existing blockchain entry, that is executed by a node in the blockchain network as part of the validation procedure. Every node in the decentralized system can have a copy of the growing blockchain 105, avoiding the need to have a centralized ledger managed by a trusted third party. Moreover, each of the nodes can validate the data/transactions, add hash values to their copy of the blockchain 105, and then broadcast these additions to other nodes in accordance with existing blockchain methodologies. In some aspects, the blockchain network 103 may be comprised of a mixture of “full” nodes and “partial” nodes. Full nodes may process the full blockchain and are validating and enforcing data integrity of the blockchain on a regular basis. Partial nodes, in contrast, are configured to interact with the blockchain in a lightweight manner, for example, by downloading block headers, and verifying only a small portion of what needs to be verified, using a distributed hash table as a database for trie nodes in place of its local hard drive. In one aspect, the blockchain clients 106 may be configured as partial nodes of the blockchain network, while other servers in the system 100 may be configured as full nodes.

In one aspect, the blockchain network 103, using certain blockchain transactions and smart contracts, may be configured to facilitate the management and execution of a cryptographically-validated, blockchain-based employee stock ownership plan. As described in detail below, cryptographic tokens representing equity stakes in a company can be created and held in the company's electronic wallet, while another set of cryptographic tokens representing stock options can be created and distributed to the electronic wallets of employees participated in the blockchain-based electronic wallet. A smart contract published to the blockchain contains functionality may be accessed (via blockchain transactions) to execute a conversion of stock option tokens into equity tokens, provided the conversion passes a verification process performed by the smart contract.

The blockchain client 106 of the server system 101 may be configured to manage a company account 107, which is associated with a particular company, corporation, or other business entity, that has an account balance of cryptographic assets, a plurality of tokens 112 or other cryptographic assets. In one aspect, the tokens 112 may include equity tokens which are cryptographic assets that represent equity stakes in the company. For example, one equity token 112 may correspond to a single equity share in the company, or a pre-defined percentage of equity in the company. The company account 107 may be configured to “store” a plurality of employee stock ownership plan (ESOP) tokens, cryptocurrency assets, and/or other types of tokens that are transferred to the company account 107 in exchange for one or more of the equity tokens. It is understood that, in many implementations of blockchain-based systems, an end-user account does not physically store units of data corresponding to units of cryptocurrency, but rather, controls (e.g., by possession of cryptographic keys) the account balance of cryptographic assets maintained by a smart contract. It is further understood that present discussion of cryptographic assets being “in”, “stored in”, “with”, or “of” an electronic wallet or account may mean an amount of cryptographic assets that are allocated to or within a balance of an electronic wallet or user account, as maintained by the internal data store of a smart contract deployed in the blockchain.

The blockchain client 108 of the client device 102 is configured to manage an employee account 109, which is associated with a particular employee of the company, that has an account balance of stock option tokens 114, cryptocurrency coins, and/or other types of cryptographic assets attributable to the employee account 109. The employee account 109 may be configured to receive one or more equity tokens 112 as a result of converting stock option tokens 114 using smart contracts, as described in further detail below.

In an aspect, the blockchain client 106 is configured to generate a blockchain transaction 116, which is a data structure specifying a transfer of cryptographic assets from one account (e.g., the company account 107) to another account (e.g., the employee account 109). The blockchain client 106 may publish the blockchain transaction 116 to the blockchain 105 by transmitting the blockchain transaction 116 to one of the nodes 104 of the blockchain network 103. The data structure of a blockchain transaction may include a plurality of data fields for facilitating and validating the transfer of stock-option-related cryptographic assets from a sender account to a recipient account, such as identifiers or addresses associated with each of the sender account and the recipient account, and the amount of cryptographic assets to be transferred from the sender to the recipient. The blockchain client 106 may be configured to create a digital signature 118, which is stored in the blockchain transaction's data structure, that is generated using the private encryption key associated with the account (e.g., company account 107) and, for example, a predetermined set of the data fields of that same blockchain transaction 116. For example, the digital signature 118 (“SIG<company>”) identifies the sender of the blockchain transaction 116 as the company account 107, which can be cryptographically verified by the blockchain network using the corresponding public encryption key associated with the company account 107.

In one aspect, the blockchain client 106 may be configured to generate one or more blockchain transactions that deploy, to the blockchain 105, one or more employee-stock-ownership (ESOP) smart contract modules 120 that are configured to manage an employee stock ownership plan and transfer equity tokens between a company (using its company account 107) and its employees (represented by their employee account 109). The ESOP smart contract module 120 is a software module comprised of computer-executable instructions or code that is run by one of the nodes 104 of the blockchain network when triggered by certain messages or transactions from other nodes or clients (e.g., blockchain clients 106, 108). The ESOP smart contract module 120 includes computer-executable instructions for creating a set of stock option tokens 114 on a blockchain that have a programmable conversion algorithm.

In one aspect, to convert a set of stock option tokens 114, the blockchain client 108 associated with the employee account 109 executes a transfer of the stock option tokens 114 accompanied by an amount of cryptocurrency assets (coins 115) using the ESOP smart contract module 120. The ESOP smart contract module 120 includes computer-executable instructions for verifying the transfer of the stock option tokens, for example, by checking that a vesting timeframe defined for the stock option tokens 114 is satisfied, or by checking that an execution price defined for the stock option tokens 114 is satisfied. If verification is successful, the ESOP smart contract module 120 may execute a transfer of the stock option tokens together with the cryptocurrency coins to the company account. Then, the ESOP smart contract module 120 executes a transfer of the corresponding equity tokens 112 to the employee account 109. An example issuance and conversion process is described in further detail below.

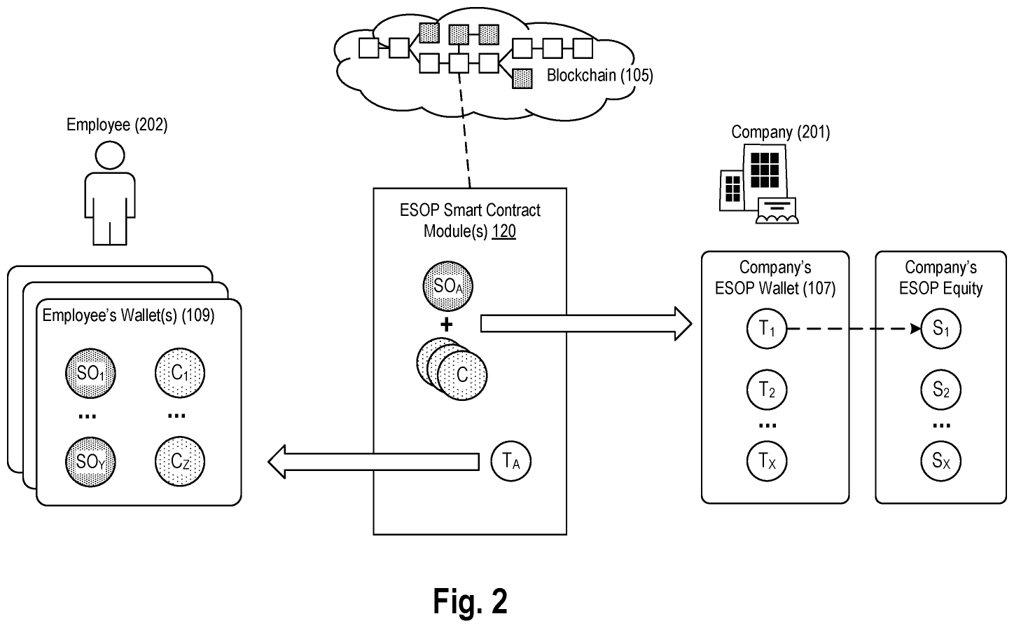

FIG. 2 is a block diagram depicting operations for issuing and converting employee stock option tokens using a blockchain smart contract, according to an exemplary aspect. As shown, a basic set of equity tokens (T₁, T₂, . . . Tₓ) representing a stake of equity (S₁, S₂, . . . Sₓ) in a company 201 is allocated to an account associated with the company (“Company's ESOP Wallet”). In some aspects, one equity token is equal to a predefined number of company shares, for example, such as 1 equity token equaling 1 share, or 10 tokens equaling 1 share, or 1 token equaling 10 shares, etc. The equity tokens may be defined based on any type of company equity, such as stock or any other security representing an ownership interest. The equity tokens may be configured to have a restricted transferability, i.e., the equity tokens may only be transferred to another wallet via the ESOP smart contract module 120, and not using other smart contracts or blockchain transactions.

In an aspect, the ESOP smart contract module 120 is deployed by the company to create a plurality of stock option tokens (SO₁, . . . SO_{Y}) for a subset of the equity tokens in the company wallet. In an example, one stock option token is created for each equity token in the subset of equity tokens. The corresponding equity token is blocked in the company wallet (i.e., cannot be transferred or used anyhow). Alternatively, the corresponding equity token can be transferred to an escrow wallet (not shown) maintained by a third-party provider. The stock option tokens can be converted back into equity tokens according to rules defined by the company and implemented by computer-executable code embedded within the smart contract 120. The stock option tokens are then transferred to an account (“Employee's Wallet 109) associated with an employee receiving the stock options.

In an aspect, the employee may exchange the stock option tokens back to equity tokens by sending the stock option tokens to the company wallet (or escrow wallet) using the ESOP smart contract module 120. As shown in FIG. 2, the employee sends at least one stock option token SO_{A} together with an amount of cryptocurrency coin C. The ESOP smart contract module 120 may verify whether the requested transfer of stock option tokens observes one or more rules or conditions that have been defined for the stock option conversion. If the rule(s) of the ESOP smart contract module is observed, then the corresponding number of equity tokens T_{A} will be transferred back to the employee wallet, and the stock option tokens SO_{A} are destroyed or disposed of in the company ESOP wallet. If the rule(s) of the ESOP smart contract module is not observed, then the stock option tokens are sent back to the employee wallet, and no conversion occurs. In one example, one of the rules of the ESOP smart contract module includes a check that a stock option token cannot be converted earlier than a predefined date, e.g., 1 week, 1 month, 1 year, etc. subsequent to the creation of the ESOP smart contract module. In another example, one of the rules of the ESOP smart contract module includes a check that the total number of converted stock option tokens cannot be larger predefined number of allowed number of tokens for the current date. If such a rule is not observed, then the stock option tokens that are not allowed to be converted (i.e., the stock option tokens in excess of the maximum amount) are transferred back to the employee wallet, and the other stock option tokens may be converted. In another example, one of the rules of the ESOP smart contract module 120 includes a check that a needed payment is received by the company.

Referring back to FIG. 1, according to one aspect, the ESOP smart contract module 120 has computer-executable instructions for constructor functionality that, when the smart contract is deployed and instantiated, creates a plurality of stock option tokens corresponding to some subset of equity tokens in the company account 107. The ESOP smart contract module 120 further has computer-executable instructions for transfer functionality that converts stock option tokens in one account into corresponding equity tokens in another account by controlling the transfer of such tokens between the accounts. The transfer functionality may include one or more rules that must be satisfied before the ESOP smart contract module 120 determines a proper transfer is authorized to take place, such as rules on the timing of conversion of the stock option tokens, the amounts of stock option tokens, and the price of converting the stock option tokens. In some aspects, the transfer functionality may include a vesting rule that verifies that a receipt datetime of an invocation of the transfer functionality that converts a stock option token to an equity token is not earlier than a predefined datetime value (such as 3 years after publication of the smart contract module to the blockchain). In some aspects, the transfer functionality may include a gradual vesting rule that verifies an amount of stock option tokens requested for conversion does not exceed a predefined amount of allowed number of equity tokens for a particular time period (e.g., relative to the current datetime value).

When deployed to the blockchain 105, the ESOP smart contract module 120 may be allocated a unique contract address associated with the smart contract, which can be used to trigger the functionality provided by the smart contract. For example, the blockchain client 106 may send a blockchain transaction to the blockchain network having a recipient address field specifying the ESOP smart contract module 120 and a payload specifying that the transfer functionality is to be triggered and an input parameter of the desired amount of stock option tokens.

In some aspects, the blockchain client 106 may generate and deploy a generalized ESOP smart contract module that contains computer-programmable rules that codify the policies and rules of the company's employee stock ownership plan as applicable to multiple employees. Such a generalized ESOP smart contract module can create the entire set of stock option tokens and can be used to facilitate the conversion of stock option tokens into equity tokens for multiple, if not all, employees. In other aspects, the blockchain client 106 may generate and deploy an individualized instance of an ESOP smart contract module for managing the conversion of stock option tokens for a single employee or a particular subset of employees. An individualized ESOP smart contract module may contain computer-executable rules having embedded values (e.g., a hard-coded value for stock option conversion date) in accordance with the employee stock ownership rules and policies applicable to that particular individual employee or subset of employees.

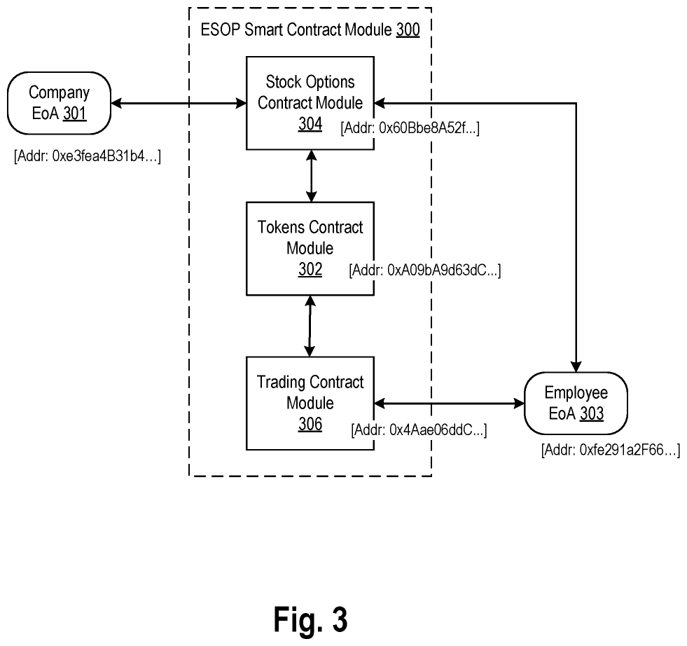

It is understood that the ESOP smart contract module 120 is depicted and described as a single software module or component for representative purposes only, and that a variety of software architectures and configurations can be used. For example, the ESOP smart contract module 120 may be implemented using multiple smart contract modules (which are all published via blockchain transactions to the blockchain and that may coordinate the conversion of stock option tokens by passing digital message between each other using internal blockchain transactions). An example of such an implementation is shown and described in conjunction with FIG. 3.

FIG. 3 is a block diagram depicting a schematic view of an employee stock ownership plan (ESOP) smart contract module 300 having a plurality of sub-modules, according to an exemplary aspect. As shown, the ESOP smart contract module 300 may be formed from plurality of sub-modules, i.e., smart contract modules that are each deployed to the blockchain, and that interact with each other by calling or sending digital messages via the blockchain. In an aspect, the ESOP smart contract module 300 includes a tokens smart contract module 302, a stock options smart contract module 304, and a trading contract module 306. Stock option tokens can be issued and converted according to the deployment and transfer operations described below.

First, the blockchain client 106 associated with the company account 301 may deploy a tokens smart contract 302 by transmitting a blockchain transaction containing the program code for the tokens smart contract as a payload. The token smart contract 302 is a smart contract module that defines a cryptographic token (e.g., equity tokens 112) that represent the company's shares or equity. The token smart contract module may also be referred to as a Stock smart contract that stores tokens that represent company stocks and includes transfer functionality to transfer them. In some aspects, the token smart contract 302 may include a contract address field that is a unique address that represents this contract in the blockchain (e.g., “0xA09bA9d63dC . . . ”) and an owner field that specifies an account (e.g., company account 301 having the address “0xe3fea4B31b4 . . . ”) that owns the smart contract and all shares after deploying the tokens smart contract. In some aspects, the token smart contract 302 may maintain a total supply value that represents a total amount of issued shares for this company, such as 1,000 shares. In some aspects, the token smart contract 302 may maintain one or more balance values that represent the amount of equity tokens each particular account owns. For example, the balance value may be implemented as a mapping of account addresses to balance values of equity tokens (e.g., “0xe3fea4B31b4 . . . =1000”). In some aspects, the tokens smart contract 302 may maintain an allowed value that specified the allowed spending of equity tokens per account. For example, the allowed value can be implemented as a nested mapping of address_owner->(address spender->value), whereby the address_owner value is an address of an account that owns the value of equity tokens in balance, the address spender is an address of the account who will be available to spend tokens from the address_owner address, and the value is an amount that the address spender can spend from address_owner. Listing 1 below provides example pseudocode for a tokens smart contract.

Contract Tokens is ERC20 {

mapping (address => int) balances;
mapping(address => mapping (address => int)) allowed;
constructor (int value) public {

totalSupply = value;
balances[msg.sender] = totalSupply;

}
function transfer(address _to, int _value) {

require(balances[msg.sender] >= _value);
balances[msg.sender] −= _value;
balances[_to] += _value;
emit Transfer(msg.sender, to, value);

}
function transferFrom(address _from, address _to, int _value) {

require(balances[_from] >= _value && allowed[_from][msg.sender] >=

_value);

balances[_from] −= _value;
balances[_to] += _value;
allowed[_from][msg.sender] −= _value;
emit Transfer(_from, _to, _value);

}
function approve(address _spender, int _value) {

allowed[msg.sender][_spender] += _value;
emit Approval(msg.sender, _spender, _value);

}
...

}

Listing 1: Pseudocode for Tokens Smart Contract

Next, the blockchain client 106 associated with the company account 301 may deploy a stock options smart contract 304. The stock options smart contract 304 is a smart contract module that defines another cryptographic token (stock option tokens) representing stock options of the company that gives an opportunity for an account holder to buy the company's shares by a predefined price. In some aspects, the stock options smart contract 304 may include a contract address field that is a unique address that represents this contract in the blockchain (e.g., “0x60Bbe8A52f . . . ”) and an owner field that specifies an account (e.g., company account 301 having the address “0xe3fea4B31b4 . . . ”) that owns the smart contract. In some aspects, the stock options smart contract 304 may include a token address field specifying the account address that represents the instance of the token smart contract module 302 for these stock options (e.g., “0xA09bA9d63dC . . . ”) that these stock options work with. In some aspects, the stock options smart contract 304 may include a price value that specifies the price per stock option token that need to be sent to the company address to exercise the stock option (e.g., “$50” per stock option token). For instance, the price value is an execution price field that defines the price that will be used to buy tokens from the Tokens smart contract module 302. In some aspects, the stock options smart contract 304 may include a total supply value that equals the tokens in the contract that is associated with the TokenAddress' balance (e.g., “100”). In some aspects, the stock options smart contract 304 may maintain one or more balance values that represent the amount of stock option tokens each particular account owns, which can be implemented using a nested mapping as described earlier. In some aspects, the stock options smart contract module 304 may include a timestamp field that stores a timestamp of the mining block in the blockchain to which the smart contract is published. Listing 2 provides example pseudocode for a stock options smart contract module.

contract StockOptions is ERC20 {

mapping (address => int) balances;
mapping (address => mapping (address => int)) allowed;
int tokenPrice;
int startDate;
address TokenAddress;
address Owner;
constructor (int _value, int _price, address _token) public {

totalSupply = _value;
balances[msg.sender] = totalSupply;
tokenPrice = _price;
startDate = block.timestamp;
TokenAddress = _token;
Owner = msg.sender;

}
function transfer(address _to, int _value) {

require(balances[msg.sender] >=_value);
balances[msg.sender] −= _value;
balances[_to] += _value;
emit Transfer(msg.sender, _to, _value);

}
...

}

Listing 2: Pseudocode for Stock Options Smart Contract

To issue stock option tokens to an employee account 303 (e.g., externally owned account, or EoA), the company's blockchain client 106 sends a blockchain transaction invoking the transfer functionality of the stock options smart contract module 304. For example, the transfer can specify an amount of 100 stock option token to be transferred to the employee account with the address “0xfe291a2F66 . . . ”, as below. As a result of the invocation of the transfer functionality, the stock options smart contract module 304 updates its internal state to update the balance field to specifying a mapping of (0xfe291a2F66 . . . =>100).
Stock Options: Owner->User (transfer(“0xfe291a2F66 . . . ”, 100)

In an aspect, the company's blockchain client 106 then sends a blockchain transaction to deploy a trading smart contract module 306. The trading smart contract module 305 is configured to store contract addresses, such as the contract address of the stock options smart contract module 304, the token smart contract module 302, and a coin smart contract module, and may include functionality to execute a stock option exercise using the smart contract modules found at the stored contract addresses. The trading smart contract module 306 may include a contract address field that is a unique address that represents this contract in the blockchain (e.g., “0x4Aae06ddC . . . ”) and an owner field that specifies an account (e.g., company account 301 having the address “0xe3fea4B31b4 . . . ”) that owns the trading smart contract 306. In other implementations, the owner field can be the stock options contract address, and a function is added to the trading smart contract that calls this contract from the stock options contract module. The trading smart contract module 306 further includes a stock options contract address field that stores the functions and the variables of the stock options smart contract module in the blockchain. Listing 3 provides example pseudocode for a Trading smart contract module.

contract Trading {

address public Owner;
StockOptions public StockOptionsData;
ERC20 public Tokens = StockOptionsData.TokenAddress( );
constructor (StockOptions optionAddress) public {

Owner = msg.sender;
StockOptionsData = optionAddress;

}
function transferERC20(ERC20 _coins,address _user,address _company, int
_value) public onlyOwner {

// verification, vesting period
require(block.timestamp − StockOptionsData.startDate( ) > VESTING_T);
require( _coins.transferFrom(_user, _company,

StockOptionsData.tokenPrice( )* value));

require(StockOptionsData.transferFrom( user, company, value));
require(Tokens.transferFrom(_company, _user, _value));

}
function IsOwner( ) public view returns (bool) {

return Owner == msg.sender;

}
modifier onlyOwner {

if (IsOwner( ))

_;

}

}

Listing 3: Pseudocode for Trading Smart Contract

In an aspect, the employee user may approve spending in a Coin smart contract (not shown) for the trading smart contract 306. The coin smart contract may be an existing smart contract module published to the blockchain that stores tokens that represent cryptocurrency (e.g., Ethereum (ETH), ERC20-compatible tokens) and includes functions for transferring them. The user may generate a blockchain transaction addressed to the Coin smart contract that invokes approve functionality in the Coin contract, resulting in an update to the Allowed mapping stored in the Coin smart contract. For example, the Allowed mapping of the Coin smart contract is updated to specify the employee account “0xfe291a2F66 . . . ” approves the spending of 5000 cryptocurrency coins to a “spender” having a contract address equal to the Trading smart contract module “0x4Aae06ddC . . . ”) (i.e., Allowed=“0xfe291a2F66 . . . ”->“0x4Aae06ddC . . . ”->5000).

The employee user may then approve spending in the stock options smart contract 304 for the trading contract 306. The employee user (e.g., via the blockchain client 108) may generate a blockchain transaction addressed to the Stock Options smart contract module 304 that invokes approve functionality in the smart contract 304, resulting in an update to the Allowed mapping stored in the stock options smart contract 304. For example, the Allowed mapping of the stock options smart contract is updated to specify the employee account “0xfe291a2F66 . . . ” approves the spending of 100 stock option tokens to a “spender” having a contract address equal to the Trading smart contract module “0x4Aae06ddC . . . ”) (i.e., Allowed=“0xfe291a2F66 . . . ”->“0x4Aae06ddC . . . ”->100).

The company then approves a spending in the token contract for the trading contract. The company (e.g., via blockchain client 106) may generate a blockchain transaction addressed to the smart contract that invokes approve functionality in the Tokens smart contract module 302, resulting in an update to the Allowed mapping stored in the Tokens smart contract. For example, the Allowed mapping of the Tokens smart contract is updated to specify the company account “0xe3fea4B31b4 . . . ” approves the spending of 100 equity tokens to a “spender” having a contract address equal to the Trading smart contract module “0x4Aae06ddC . . . ”) (i.e., Allowed=“0xe3fea4B31b4 . . . ”->“0x4Aae06ddC . . . ”->100).

Finally, the trading smart contract module 306 may use a transfer function (e.g., “transferERC20”) to sell the companies' shares by a predefined price for cryptocurrency coins. In the example shown in Listing 3, the transferERC20 method is modified by a “onlyOwner” modifier. In implementations in which the Coin smart contract uses an Ethereum-based token (ETH), the transfer functionality of the Coin smart contract may use a special modifier” payable.” In such cases, the ETH will be sent to the contract address where this payable function is located.

In some aspects, the trading smart contract module 306 may send blockchain messages to each of the stock options smart contract module 304, the tokens smart contract module 302, and the coin smart contract module invoking respective transfer functionalities. As shown in the example pseudo-code in Listing 3, the trading smart contract module may execute calls such as “coins.transferFrom(_user, _company, StockOptionsData.tokenPrice( )*_value)”, StockOptionsData.transferFrom(_user, _company, _value), and Tokens.transferFrom(_company, _user, _value) to implement the above-approved spending. As a result, each of the stock options smart contract module 304, the tokens smart contract module 302, and the coin smart contract module update their respective balances according to the transfers. For example, the stock options smart contract module 304 updates its balance field to include a mapping that indicates the employee account (“0xfe291a2F66 . . . ”) has a balance of 0 remaining stock option tokens, and the company account (“0xe3fea4B31b4 . . . ”) has a balance of 100 stock option tokens; and the Tokens smart contract module 302 updates its balance field to include a mapping that indicates the employee account (“0xfe291a2F66 . . . ”) has a balance of 100 equity tokens, and the company account (“0xe3fea4B31b4 . . . ”) has a balance of 900 equity tokens. Additionally, the Allowed fields of the respective smart contract modules may be modified to set the approved spending for each entry to 0, in response to the completion of the corresponding spending.

In some aspects, the executable-code for verifying rules related to the exercise of stock options can be encoded within the transfer function of the Trading smart contract module 306. As shown in Listing 3, the transfer functionality includes a vesting period check that throws an error if the time elapsed since the stock option smart contract was started is less than a threshold period of time (e.g., “block.timestamp—StockOptionsData.startDate( )>VESTING_T)”). In other implementations, the rules may be encoded in computer-executable code found in the approve functionality of a smart contracts module (e.g., stock options smart contract module, tokens smart contract module).

It is further understood that the present disclosure provides for implementations in which one or more smart contract modules can be combined or re-arranged into a single smart contract module. For instance, the stock options smart contract module could be combined with the trading smart contract module into a single smart contract module. In such a case, rather than use a transfer function, this embodiment may execute change owner functionality to effectuate the transfer of stock options tokens between employee accounts and company accounts. Furthermore, the stock options smart contract module 304 may be extended to store options with different respective prices (e.g., a price mapping field that indicates one employee's stock options have a first exercise price, and a second employee's stock options have a second, different exercise price.)

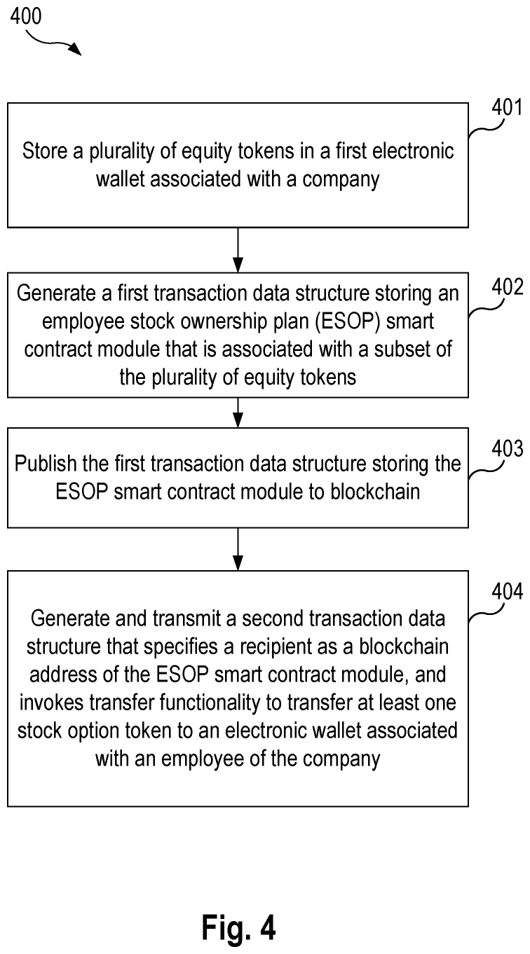

FIG. 4 is a flowchart of a method 400 for executing a blockchain-based transaction according to an exemplary aspect. It is noted that the following description of the exemplary method makes reference to the system and components described above.

The method 400 begins at step 401, wherein a first computing device (e.g., server system 101) associated with a company allocates a plurality of equity tokens to a first electronic wallet associated with a company, wherein each equity token represents a stake in equity in the company. In some aspects, the blockchain client 106 of the server system 101 deploys a smart contract that causes an amount of equity tokens to be “stored” in the company's electronic wallet, by updating the internal state of the blockchain VM to reflect an updated balance. In some aspects, the step of storing the plurality of equity tokens may be performed by deploying a tokens smart contract sub-module to the distributed ledger that initializes a balance of equity tokens to the company account. In some aspects, the first electronic wallet comprises an account controlled by a private encryption key, wherein the private encryption key is used to digitally sign the transaction data structures.

At step 402, the company's blockchain client 106 may generate a first transaction data structure storing an employee stock ownership plan (ESOP) smart contract module that is associated with a subset of the plurality of equity tokens. The ESOP smart contract module may include computer-executable instructions configured to execute, at a server-side node, constructor functionality that creates a plurality of stock option tokens corresponding to the subset of the equity tokens in the first electronic wallet associated with the company, and execute, at the server-side node, transfer functionality that converts at least a portion of the stock option tokens in a second electronic wallet to a corresponding amount of equity tokens.

In some aspects, the ESOP smart contract module may include computer-executable instructions to verify one or more rules associated with a requested conversion of the portion of the stock option tokens to the corresponding amount of equity tokens, and responsive to verifying the requested conversion, transfer the corresponding amount of equity tokens to the second electronic wallet. Responsive to not verifying the requested conversion, the ESOP smart contract module is configured to instead refrain from transferring the corresponding amount of equity tokens to the second electronic wallet. In some instances, the ESOP smart contract may instead return the portion of the stock option tokens back to the second electronic wallet. In some aspects, the ESOP smart contract module further includes computer-executable instructions configured to verify that a receipt datetime of an invocation of the transfer functionality that converts a stock option token to an equity token is not earlier than a predefined datetime value. In some implementations, the predefined datetime value can be set to a timestamp indicating the date and time of the blockchain block of the smart contract module. In some aspects, the ESOP smart contract module defines the predefined datetime value is specified relative to a datetime that the ESOP smart contract module is published to the distributed ledger. In some aspects, the ESOP smart contract module further includes computer-executable instructions configured to verify that an amount of stock option tokens requested for conversion does not exceed a predefined amount of allowed number of equity tokens for a current datetime. In some aspects, the ESOP smart contract module further includes computer-executable instructions configured to verify that an amount of cryptocurrency coins is transferred to the first electronic wallet associated with the company. In some aspects, the ESOP smart contract module specifies a total supply value that equals the number of tokens in the subset of equity tokens.

At step 403, the blockchain client 106 may publish the first transaction data structure storing the ESOP smart contract module to a decentralized ledger maintained by a network of server-side nodes.

At step 404, the blockchain client 106 may subsequently generate and transmit a second transaction data structure that specifies a recipient as a blockchain address of the ESOP smart contract module. The second transaction data structure is generated to include program code that invokes transfer functionality of the ESOP smart contract module for transferring at least one stock option token to an electronic wallet associated with an employee of the company. In some aspects, the transfer functionality of the ESOP smart contract module has computer-executable instructions configured to modify an internal data store of the server-side node that represents an execution state of the ESOP smart contract module to update a balance of stock option tokens for the second electronic wallet and the first electronic wallet associated with the company.

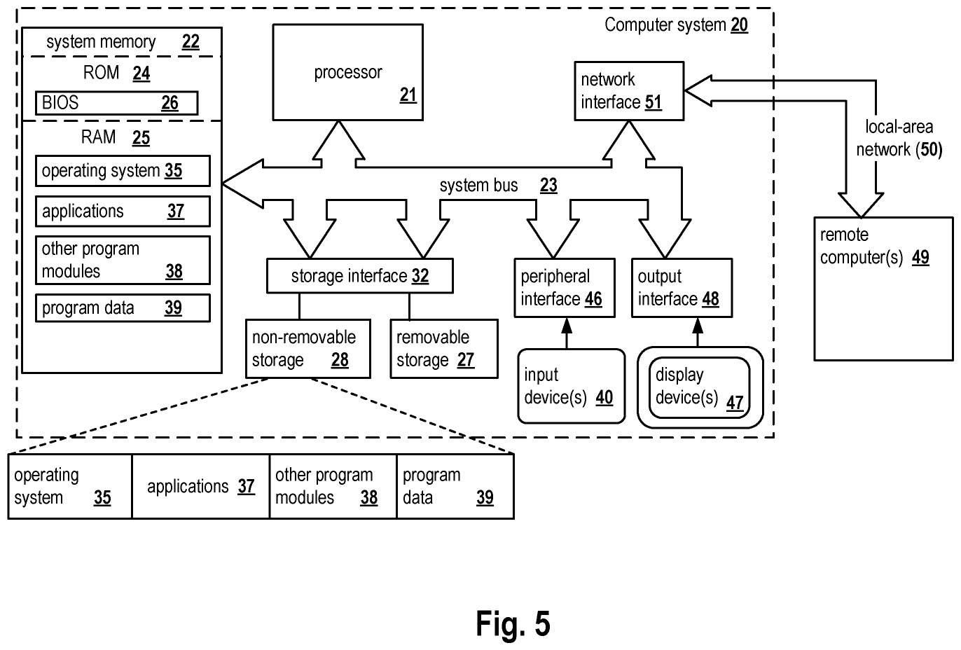

FIG. 5 is a block diagram illustrating a computer system 20 on which aspects of systems and methods for generating a blockchain data structure for executing an employee stock ownership plan may be implemented in accordance with an exemplary aspect. It should be noted that the computer system 20 can correspond to the server system 101 or the client device 102, for example, described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 5, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for generating a blockchain data structure for executing an employee stock ownership plan, the method comprising:
allocating a plurality of equity tokens to a first electronic wallet associated with a company, wherein each equity token represents a stake in equity in the company;
generating a first transaction data structure storing an employee stock ownership plan (ESOP) smart contract module, wherein the ESOP smart contract module is associated with a subset of the plurality of equity tokens and comprises computer-executable instructions configured to:
execute, at a server-side node, constructor functionality that creates a plurality of stock option tokens corresponding to the subset of the equity tokens in the first electronic wallet associated with the company,
execute, at the server-side node, transfer functionality that converts at least a portion of the stock option tokens stored at a second electronic wallet to a corresponding amount of equity tokens; and
publishing the first transaction data structure storing the ESOP smart contract module to a decentralized ledger maintained by a network of server-side nodes.

2. The method of claim 1, further comprising:
transmitting a second transaction data structure that specifies a recipient as a blockchain address of the ESOP smart contract module, wherein the second transaction data structure invokes transfer functionality of the ESOP smart contract module for transferring at least one stock option token to an electronic wallet associated with an employee of the company.

3. The method of claim 1, wherein the transfer functionality of the ESOP smart contract module comprises computer-executable instructions configured to:
verify one or more rules associated with a requested conversion of the portion of the stock option tokens to the corresponding amount of equity tokens;
responsive to verifying the requested conversion, transfer the corresponding amount of equity tokens to the second electronic wallet; and
responsive to not verifying the requested conversion, refraining from transferring the corresponding amount of equity tokens to the second electronic wallet.

4. The method of claim 1, wherein the ESOP smart contract module further comprises computer-executable instructions configured to verify that a receipt datetime of an invocation of the transfer functionality that converts a stock option token to an equity token is not earlier than a predefined datetime value.

5. The method of claim 4, wherein the ESOP smart contract module defines the predefined datetime value is specified relative to a datetime that the ESOP smart contract module is published to the distributed ledger.

6. The method of claim 1, wherein the ESOP smart contract module further comprises computer-executable instructions configured to verify that an amount of stock option tokens requested for conversion does not exceed a predefined amount of allowed number of equity tokens for a current datetime.

7. The method of claim 1, wherein the ESOP smart contract module further comprises computer-executable instructions configured to verify that an amount of cryptocurrency coins is transferred to the first electronic wallet associated with the company.

8. The method of claim 1, wherein allocating the plurality of equity tokens comprises deploying a tokens smart contract sub-module to the distributed ledger.

9. The method of claim 1, wherein the transfer functionality of the ESOP smart contract module comprises computer-executable instructions configured to:
modify an internal data store of the server-side node that represents an execution state of the ESOP smart contract module to update a balance of stock option tokens for the second electronic wallet and the first electronic wallet associated with the company.

10. The method of claim 1, wherein the ESOP smart contract module specifies a total supply value that equals the number of tokens in the subset of equity tokens.

11. A system for generating a blockchain data structure for executing an employee stock ownership plan, the system comprising:
a memory; and
a hardware processor coupled to the memory and configured to:
allocate a plurality of equity tokens to a first electronic wallet associated with a company, wherein each equity token represents a stake in equity in the company;
generate a first transaction data structure storing an employee stock ownership plan (ESOP) smart contract module, wherein the ESOP smart contract module is associated with a subset of the plurality of equity tokens and comprises computer-executable instructions configured to:
execute, at a server-side node, constructor functionality that creates a plurality of stock option tokens corresponding to the subset of the equity tokens in the first electronic wallet associated with the company,
execute, at the server-side node, transfer functionality that converts at least a portion of the stock option tokens stored at a second electronic wallet to a corresponding amount of equity tokens; and
publish the first transaction data structure storing the ESOP smart contract module to a decentralized ledger maintained by a network of server-side nodes.

12. The system of claim 11, wherein the hardware processor is further configured to:
transmit a second transaction data structure that specifies a recipient as a blockchain address of the ESOP smart contract module, wherein the second transaction data structure invokes transfer functionality of the ESOP smart contract module for transferring at least one stock option token to an electronic wallet associated with an employee of the company.

13. The system of claim 11, wherein the transfer functionality of the ESOP smart contract module comprises computer-executable instructions configured to:
verify one or more rules associated with a requested conversion of the portion of the stock option tokens to the corresponding amount of equity tokens;
responsive to verifying the requested conversion, transfer the corresponding amount of equity tokens to the second electronic wallet; and
responsive to not verifying the requested conversion, refraining from transferring the corresponding amount of equity tokens to the second electronic wallet.

14. The system of claim 11, wherein the ESOP smart contract module further comprises computer-executable instructions configured to verify that a receipt datetime of an invocation of the transfer functionality that converts a stock option token to an equity token is not earlier than a predefined datetime value.

15. The system of claim 14, wherein the ESOP smart contract module defines the predefined datetime value is specified relative to a datetime that the ESOP smart contract module is published to the distributed ledger.

16. The system of claim 11, wherein the ESOP smart contract module further comprises computer-executable instructions configured to verify that an amount of stock option tokens requested for conversion does not exceed a predefined amount of allowed number of equity tokens for a current datetime.

17. The system of claim 11, wherein the ESOP smart contract module further comprises computer-executable instructions configured to verify that an amount of cryptocurrency coins is transferred to the first electronic wallet associated with the company.

18. The system of claim 11, wherein the processor configured to allocate the plurality of equity tokens is further configured to deploy a tokens smart contract sub-module to the distributed ledger.

19. The system of claim 11, wherein the transfer functionality of the ESOP smart contract module comprises computer-executable instructions configured to:
modify an internal data store of the server-side node that represents an execution state of the ESOP smart contract module to update a balance of stock option tokens for the second electronic wallet and the first electronic wallet associated with the company.

20. The system of claim 11, wherein the ESOP smart contract module specifies a total supply value that equals the number of tokens in the subset of equity tokens.

21. A non-transitory computer readable medium comprising computer-executable instructions for generating a blockchain data structure for executing an employee stock ownership plan, including instructions for:
allocating a plurality of equity tokens to a first electronic wallet associated with a company, wherein each equity token represents a stake in equity in the company;
generating a first transaction data structure storing an employee stock ownership plan (ESOP) smart contract module, wherein the ESOP smart contract module is associated with a subset of the plurality of equity tokens and comprises computer-executable instructions configured to:
execute, at a server-side node, constructor functionality that creates a plurality of stock option tokens corresponding to the subset of the equity tokens in the first electronic wallet associated with the company,
execute, at the server-side node, transfer functionality that converts at least a portion of the stock option tokens stored at a second electronic wallet to a corresponding amount of equity tokens; and
publishing the first transaction data structure storing the ESOP smart contract module to a decentralized ledger maintained by a network of server-side nodes.

22. The non-transitory computer readable medium of claim 21, further comprising computer-executable instructions for:
transmitting a second transaction data structure that specifies a recipient as a blockchain address of the ESOP smart contract module, wherein the second transaction data structure invokes transfer functionality of the ESOP smart contract module for transferring at least one stock option token to an electronic wallet associated with an employee of the company.

23. The non-transitory computer readable medium of claim 21, wherein the transfer functionality of the ESOP smart contract module comprises computer-executable instructions configured to:
verify one or more rules associated with a requested conversion of the portion of the stock option tokens to the corresponding amount of equity tokens;
responsive to verifying the requested conversion, transfer the corresponding amount of equity tokens to the second electronic wallet; and
responsive to not verifying the requested conversion, refraining from transferring the corresponding amount of equity tokens to the second electronic wallet.
